(19) United States
(12) Patent Application Publication
(10) Pub. No.: US 2023/0242055 A1
(43) Pub. Date: Aug. 3, 2023

(54) ENERGY ABSORBER STRUCTURE FOR VEHICLE SKATEBOARD

(71) Applicant: Lordstown EV Corporation, Lordstown, OH (US)

(72) Inventors: Ganesh Shete, Lordstown, OH (US); Indrani Gadgil, Lordstown, OH (US); Avinash Mudalagi, Lordstown, OH (US); Sudhir Maddireddy, Lordstown, OH (US); Sachin Ratnaparkhi, Lordstown, OH (US)

(73) Assignee: Lordstown EV Corporation, Lordstown, OH (US)

(21) Appl. No.: 18/105,026

(22) Filed: Feb. 2, 2023

Related U.S. Application Data
(60) Provisional application No. 63/306,264, filed on Feb. 3, 2022.

(51) Int. Cl. B60R 19/18

(52) U.S. Cl. CPC B60R 19/18; B60R 2019/1813; B60Y 2200/91

(57) ABSTRACT

A front energy absorbing assembly for use in a front skateboard structure of an electric vehicle includes a fixed mount bracket including a platform and a connector extending downward from the platform. The front energy absorbing assembly further includes a crush tube that includes a plurality of main sidewalls. Each of the main sidewalls includes one or more apertures. The crush tube further includes a plurality of auxiliary sidewalls. Each of the auxiliary sidewalls is coupled between two main sidewalls of the plurality of main sidewalls. The connector is received within at least one of the one or more apertures. A side skateboard structure includes a frame that includes a first frame side and a second frame side. The side skateboard structure further includes one or more side energy absorbing assemblies disposed along at least one of the first frame side or the second frame side.

### CROSS-REFERENCE TO RELATED APPLICATIONS

The present application claims priority to U.S. Provisional Appln. No. 63/306,264 filed Feb. 3, 2022, the entire contents of which are incorporated herein by reference.

### TECHNICAL FIELD

The present disclosure relates generally to a vehicle skateboard structure, and, in particular, to a vehicle skateboard structure for electric vehicles.

### BACKGROUND

Vehicles, including electric vehicles, have crash protection measures. Structural crash performance metrics, such as energy absorption and the resulting deceleration, may be taken into account for the structures to meet regulatory requirements and consumer metrics.

### SUMMARY

One embodiment relates to a front energy absorbing assembly for use in a front skateboard structure of a vehicle. The front energy absorbing assembly including a fixed mount bracket that includes a platform and a connector extending downward from the platform. The front energy absorbing assembly further including a crush tube that includes a plurality of main sidewalls. Each of the main sidewalls includes one or more apertures. The crush tube further includes a plurality of auxiliary sidewalls. Each of the auxiliary sidewalls coupled between two main sidewalls of the plurality of main sidewalls. The connector is received within at least one of the one or more apertures.

In some embodiments, the fixed mount bracket further includes one or more side panels extending downward from the platform. At least a portion of the one or more side panels is coupled to at least one of a main sidewall of the plurality of main sidewalls or an auxiliary sidewall of the plurality of auxiliary sidewalls.

In some embodiments, the at least the portion of the one or more side panels is welded to the at least one of the main sidewall or the one auxiliary sidewall.

In some embodiments, the plurality of main sidewalls includes four main sidewalls, the plurality of auxiliary sidewalls includes four auxiliary sidewalls, and the crush tube includes an octagonal cross-section.

In some embodiments, the crush tube further includes a first end and a second end. The one or more apertures include a first aperture defined by a first diameter and a second aperture defined by a second diameter. The first diameter being larger than the second diameter. The first aperture is disposed proximate to the first end. The second aperture is disposed between the first aperture and the second end.

In some embodiments, the first diameter and the second diameter are between 10 mm and 18 mm.

In some embodiments, the one or more apertures further comprise a third aperture, a fourth aperture, a fifth aperture, and a sixth aperture.

In some embodiments, the plurality of main sidewalls include a first main sidewall and a second main sidewall. The first main sidewall includes a first length. The second main sidewall includes a second length. The first length is longer than the second length. The crush tube includes a first end, a second end opposing the first end, a first interface plane disposed proximate the first end, and a second interface plane disposed proximate the second end. The first interface plane is angled relative to the second interface plane.

One embodiment relates to a side skateboard structure for use in a vehicle. The side skateboard structure including a frame that includes a first frame side and a second frame side opposing the first frame side. The side skateboard structure further including one or more side energy absorbing assemblies disposed along at least one of the first frame side or the second frame side. Each of the side energy absorbing assemblies including a first bracket, a second bracket, a first side bracket, and a second side bracket. The first bracket including a first bracket upper surface and a first bracket side surface extending downward from the first bracket upper surface. The second bracket including a first end, a second end opposing the first end, a second bracket upper surface extending between the first end and the second end, a second bracket lower surface extending between the first end and the second end and opposing the second bracket upper surface, and a second bracket side surface extending between the first end and the second end and extending between the second bracket upper surface and the second bracket lower surface. At least a portion of the second bracket side surface is coupled to at least a portion of the first bracket side surface. The first side bracket is disposed at the first end. The first side bracket including a first side bracket portion coupled to a first portion of the second bracket upper surface, and a second side bracket portion coupled to a first portion of the second bracket lower surface. The second side bracket disposed at the second end. The second side bracket including a third side bracket portion coupled to a second portion of the second bracket upper surface, and a fourth side bracket portion coupled to a second portion of the second bracket lower surface.

In some embodiments, the side skateboard structure further includes one or more crossbars extending between the first frame side and the second frame side. The one or more crossbars including a first crossbar end coupled to the first frame side, and a second crossbar end opposing the first end and coupled to the second frame side. The one or more crossbars is provided with an upward step disposed between the first crossbar end and the second crossbar end. The upward step extends above the first crossbar end and the second crossbar end.

In some embodiments, the one or more side energy absorbing assemblies include two side energy absorbing assemblies disposed along the first frame side and two side energy absorbing assemblies disposed along the second frame side.

In some embodiments, the one or more side energy absorbing assemblies include a first side energy absorbing assembly and a second side energy absorbing assembly. The first side energy absorbing assembly include a first length. The second side energy absorbing assembly include a second length. The second length is longer than the first length.

In some embodiments, the at least the portion of the second bracket side surface is welded to the at least the portion of the first bracket side surface. The first side bracket portion is welded to the first portion of the second bracket upper surface. The second side bracket portion is welded to the first portion of the second bracket lower surface. The third side bracket portion is welded to the second portion of the second bracket upper surface. The fourth side bracket portion is welded to the second portion of the second bracket lower surface.

One embodiment relates to a side skateboard structure for use in a vehicle. The side skateboard structure includes a frame that includes a first frame side and a second frame side opposing the first frame side. The side skateboard structure further includes one or more side energy absorbing assemblies disposed along at least one of the first frame side or the second frame side. Each of the side energy absorbing assemblies includes a first bracket that includes a first bracket upper surface and a first bracket side surface extending downward from the first bracket upper surface. The first bracket upper surface includes an s-shaped cross-section (e.g., a serpentine or a sinuous shape cross-section achieved by a plurality of bends in the first bracket upper surface). Each of the side energy absorbing assemblies further includes a second bracket that includes a first end, a second end opposing the first end, a second bracket lower surface extending between the first end and the second end, and a second bracket side surface extending between the first end and the second end and extending upward from the second bracket lower surface. At least a portion of the second bracket side surface is coupled to at least a portion of the first bracket side surface.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appended at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a top view of a front skateboard structure including a bumper and a front energy absorbing assembly, according to an embodiment;

FIG. 2 is a top view of the front skateboard structure of FIG. 1 excluding the bumper, according to an embodiment;

FIG. 3 is a side view of the front energy absorbing assembly of FIGS. 1 and 2 including a crush tube and a fixed mount bracket excluding a connector, according to an embodiment;

FIG. 4 is a side view of the front energy absorbing assembly of FIGS. 1 and 2 including the crush tube and the connector, according to an embodiment;

FIG. 5 is a side view of the front energy absorbing assembly including the crush tube and a tow hook, according to an embodiment;

FIGS. 6 and 7 are a perspective views of the crush tube of FIGS. 3-5, according to an embodiment;

FIG. 8 is a perspective view of the fixed mount bracket of FIG. 3 excluding the connector, according to an embodiment;

FIGS. 9 and 10 are perspective views of a side skateboard structure including a first side energy absorbing assembly, according to an embodiment;

FIG. 11 is a view of Detail A in FIG. 9 including the first side energy absorbing assembly, according to an embodiment;

FIG. 12 is a top view of a side skateboard structure including a first frame side, a second frame side, and the first side energy absorbing assembly, according to another embodiment;

FIG. 13 is a perspective view of the side skateboard structure of FIG. 12, according to an embodiment;

FIG. 14 is a perspective view of the first side energy absorbing assembly and the second frame side of FIGS. 12 and 13, according to an embodiment;

FIG. 15 is a perspective view of the first side energy absorbing assembly of FIGS. 12-14, according to an embodiment;

FIG. 16 is a side view of the first side energy absorbing assembly of FIG. 15, according to an embodiment;

FIG. 17 is perspective view of the first side energy absorbing assembly under no crushing impact, according to an embodiment;

FIG. 18 is perspective view of the first side energy absorbing assembly under partial crushing impact, according to an embodiment;

FIG. 19 is perspective view of the first side energy absorbing assembly under full crushing impact, according to an embodiment;

FIG. 20 is a perspective view of the side skateboard structure in an undeformed condition, according to an embodiment;

FIG. 21 is a perspective view of the side skateboard structure in a deformed condition, according to an embodiment;

FIG. 22 is a top view of the side skateboard structure including a seat assembly, according to an embodiment;

FIG. 23 is a side view of the side skateboard structure of FIG. 22 including the seat assembly, according to an embodiment; and

FIG. 24 is a perspective view of the side skateboard structure of FIGS. 22 and 23 including the seat assembly, according to an embodiment.

Reference is made to the accompanying drawings throughout the following detailed description. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a variety of different configurations, all of which are explicitly contemplated and made part of this disclosure.

### DETAILED DESCRIPTION

Embodiments described herein relate generally to a vehicle skateboard structure including a front skateboard structure and a side skateboard structure. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Modern vehicles, including electric vehicles, hybrid vehicles, gas vehicles, and the like, are typically equipped with crash protection measures, such as force absorbing structures. In some configurations, placement of vehicle systems or vehicle system components, such as a cooling system (e.g., including condenser, radiator, fan, etc.), powertrain system (e.g., including motor, transmission, controller, etc.), power storage system (e.g., battery, etc.), can block the force absorbing structures from properly absorbing a force upon impact. Furthermore, in electrical and hybrid vehicles, additional crash protection is warranted to avoid crushing or penetrating the battery (e.g., High Voltage (HV) battery, etc.). In some vehicles, the battery may be disposed near a bottom portion of the vehicle, proximate to the vehicle skateboard structure.

Implementations herein are related to a vehicle skateboard structure including a front skateboard structure and a side skateboard structure. In some embodiments, the front skateboard structure includes front energy absorbing assemblies configured to absorb energy transferred to the front skateboard structure upon impact. In some embodiments, the side skateboard structure includes first side energy absorbing assemblies and second side energy absorbing assemblies configured to absorb energy transferred to the side skateboard structure upon impact.

In some implementations, the front skateboard structure disclosed herein is configured to comply with at least one of the Federal Motor Vehicle Safety Standards (FMVSS) 208, which include a flat frontal rigid barrier impact at 25 miles per hour (mph) and 35 mph, an angular rigid barrier impacts at both left hand (LH) and right hand (RH) side of the vehicle at 25 mph, and a 40% oblique deformable barrier at 25 mph. In some implementations, the front skateboard structure disclosed herein is configured to comply with all FMVSS 208 specifications.

### II. Overview of Example Front Skateboard Structure

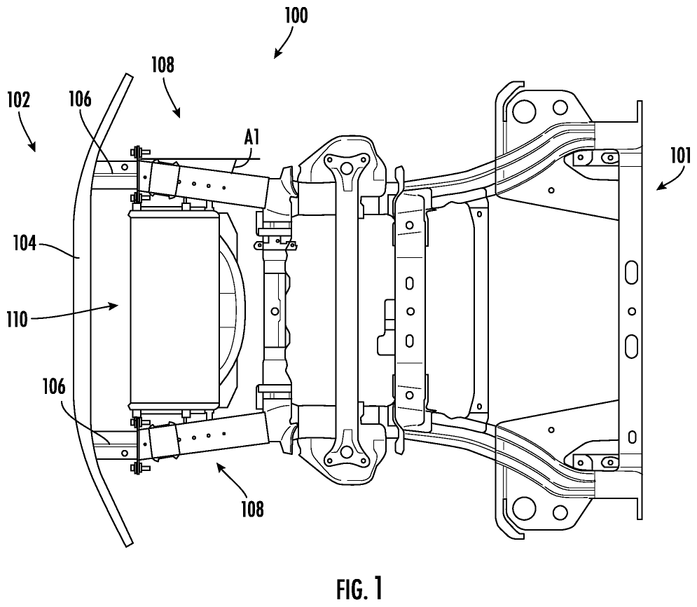

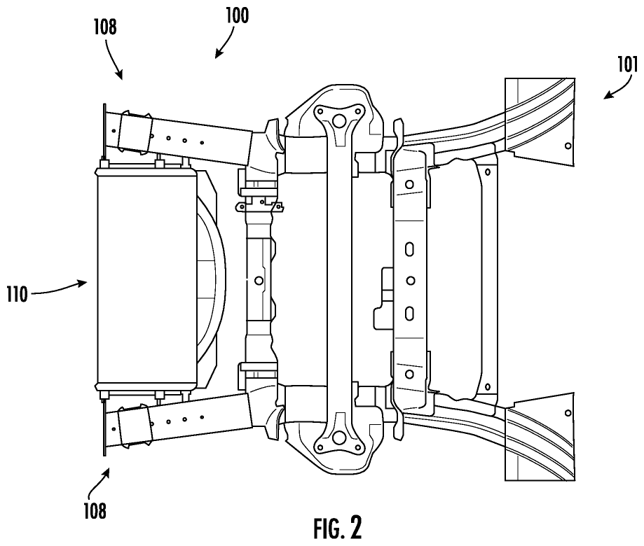

FIGS. 1 and 2 illustrate a front skateboard structure 100 configured to be disposed proximate to a front portion of a vehicle, such as an electric vehicle, and in particular an electric pickup truck, although the present disclosure is not limited to these vehicles. In some embodiments, the front skateboard structure 100 is disposed proximate to a rear portion of the vehicle. The front skateboard structure 100 may be coupled to a frame 101 that is configured to provide structural support to the vehicle. In some embodiments, the front skateboard structure 100 is coupled to a front portion of the frame 101. In other embodiments, the front skateboard structure 100 is coupled to a rear portion of the frame 101. The front skateboard structure 100 is configured to absorb energy generated from a frontal impact between the vehicle and an external object (e.g., another vehicle, rigid object, beam, etc.) to reduce transfer of energy to a passenger compartment of the vehicle and/or other components of the vehicle.

The front skateboard structure 100 may include a bumper 102 disposed at a front portion of the front skateboard structure 100. The bumper 102 may include an impact bar 104 disposed at a front portion of the bumper 102. In some embodiments, the impact bar 104 is configured to be a first component of the vehicle that makes contact with an external object upon front vehicle impact (e.g., impact proximate to the front portion of the vehicle). The bumper 102 may further include bar connectors 106 coupled to the impact bar 104. In some embodiments, the bar connectors 106 include one bar connector 106, two bar connectors 106, five bar connectors 106, or the like. The bar connectors 106 are coupled to the impact bar 104 such that lengths of the bar connectors 106 are perpendicular to a length of the impact bar 104. In some embodiments, the bar connectors 106 are coupled to the impact bar 104 via welding, adhesive, fasteners (e.g., bolts, screws, nuts, studs, etc.), and/or the like, or a combination of the foregoing. The bar connectors 106 are configured to transfer energy received from the impact bar 104 to other components of the front skateboard structure 100.

The front skateboard structure 100 may further include a plurality of front energy absorbing assemblies 108 that are configured to absorb energy from impact. In some embodiments, the front energy absorbing assemblies 108 include two front energy absorbing assemblies 108, five front energy absorbing assemblies 108, or the like. In some examples, (i) a first of the two front energy absorbing assemblies 108 is disposed proximate a left side of the bumper 102 and is configured to absorb energy proximate the left side of the bumper 102, and (ii) a second of the two front energy absorbing assemblies 108 is disposed proximate a right side of the bumper 102 and is configured to absorb energy proximate the right side of the bumper 102. Each of the front energy absorbing assemblies 108 may be coupled to one of the bar connectors 106. In some embodiments, the front energy absorbing assemblies 108 may be coupled to the bar connectors 106 via fasteners. In other embodiments, the front energy absorbing assemblies 108 may be coupled to the bar connectors 106 via welding, adhesive, and/or the like. In some embodiments, at least one of the front energy absorbing assemblies 108 is angled relative to at least one of the bar connectors 106 at an angle A1. For example, an assembly central axis of each of the front energy absorbing assemblies 108 extending along a length of the front energy absorbing assemblies 108 is angled relative to a bar central axis of one of the bar connectors 106 at the angle A1.

In some embodiments, the angle A1 is between approximately 0 degrees and approximately 90 degrees (e.g., 10 degrees, 47 degrees, etc.). In some embodiments, the angle A1 is between approximately 0 degrees and approximately 20 degrees (e.g., 7 degrees, etc.). In some embodiments, A1 may be about 7.5 degrees, between about 5 to about 10 degrees, between about 7 to about 12 degrees, or between about 6.5 to about 15.5 degrees, or greater or less than 7.5 degrees. A cooling module (cooler) 110 may be disposed between the front energy absorbing assemblies 108 and may be easily installed or removed given the additional space allowed for by the angled orientation of at least part of the front energy absorbing assemblies 108. In particular, the angle A1 allows for a clearance where the cooling module 110 and/or another component may be placed.

The cooling module 110 may be configured to provide temperature control, via cooling and/or heating, to a passenger compartment of the vehicle and/or components of the vehicle (e.g., battery, motors, transmission, etc.). In some embodiments, the cooling module 110 includes a condenser, radiator, and fan module (CRFM).

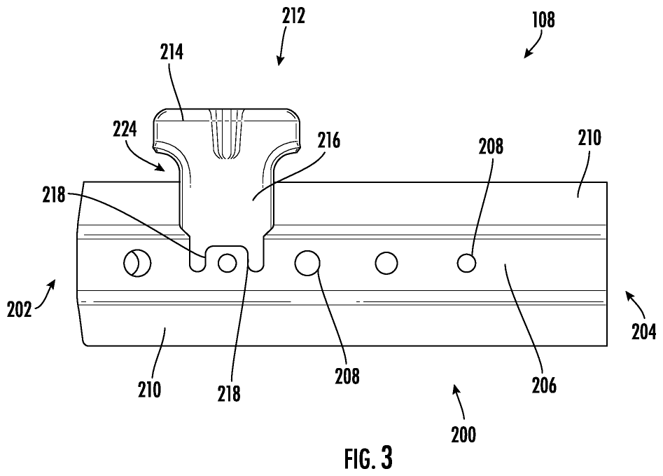

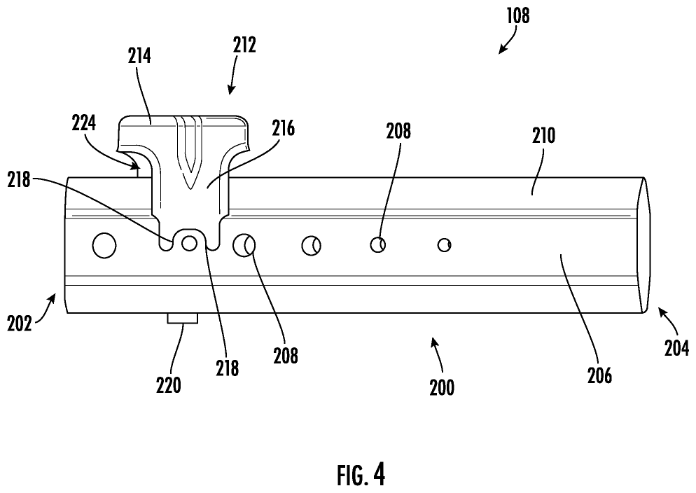

FIGS. 3-5 illustrates one of the front energy absorbing assemblies 108. It is to be appreciated that the description disclosed herein for one of the front energy absorbing assemblies 108 may apply to all of the front energy absorbing assemblies 108. Each of the front energy absorbing assemblies 108 includes a crush tube 200. The crush tube 200 includes a first end 202 and a second end 204 opposing the first end 202. In some embodiments, the crush tube 200 includes an octagonal cross-section. In some examples, the octagonal cross-section of the crush tube 200 allows for higher energy absorption by the crush tube 200 by engaging a relatively greater number of sides relative to a cross-section with lesser number of sides. In some examples, the octagonal cross-section of the crush tube 200 allows for offset loading as observed with directional bending of the crush tube 200. In other embodiments, the crush tube 200 includes a circular cross-section. In yet other embodiments, the crush tube 200 includes a rectangular, triangular, ovoidal, heptagonal, pentagonal, hexagonal, or the like, cross-section. In some embodiments, the crush tube 200 is formed (e.g., manufactured from, etc.) at least in part from metallic material, including metals, metal alloys, or combinations thereof. In some embodiments, the crush tube 200 is formed at least in part from one or more of an aluminum alloy, a zinc alloy, a magnesium alloy, or a copper-based alloy suitable for manufacturing (e.g., high-pressure die casting, rolling, bending, etc.). By way of example, the crush tube 200 may be manufactured wholly out of HSLA 420 steel. In some embodiments, the crush tube 200 may be defined as a tubular member, such that the crush tube 200 includes a solid outer portion and a hollow inner portion, where the hollow inner portion reduces an overall weight of the crush tube 200 relative to the crush tube 200 being a solid member (e.g., lacking the hollow inner portion, etc.). In other embodiments, the crush tube 200 is the solid member, such that the crush tube 200 does not include the hollow inner portion.

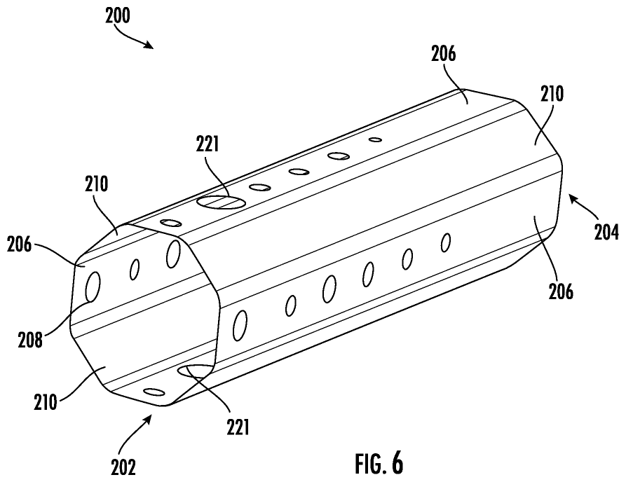

As illustrated in FIGS. 6 and 7, the crush tube 200 further includes a plurality of main sidewalls 206 extending from the first end 202 to the second end 204 of the crush tube 200. In some embodiments, the main sidewalls 206 are smooth. In other embodiments, the main sidewalls 206 are textured (e.g., rough, etc.). For example, the main sidewalls 206 may include structural features (e.g., ribs, guides, etc.) disposed along a length of the main sidewalls 206. In some embodiments, the main sidewalls 206 are substantially flat. In other embodiments, the main sidewalls 206 are curved. For example, the main sidewalls 206 may include a semi-circular cross-section. In some embodiments, the main sidewalls 206 include two main sidewalls 206, four main sidewalls 206, seven main sidewalls 206, or the like. In some embodiments, the main sidewalls 206 include a constant thickness along a length of the main sidewalls 206. In other embodiments, the main sidewalls 206 include a varying thickness along the length of the main sidewalls 206. In some embodiments, a main sidewall thickness of the main sidewalls 206 is between approximately 1.5 millimeter (mm) to approximately 3.5 mm. For example, the main sidewall thickness is approximately 2.5 mm, approximately 2.86 mm, approximately 3.01 mm, or the like. Other dimensions may be utilized in alternative embodiments.

Each of the main sidewalls 206 may include one or more apertures 208. In some embodiments, the one or more apertures 208 are configured to function as crush initiators. For example, during deformation of the crush tube 200 upon impact, at least one of the one or more apertures 208 initiates the deformation of the crush tube 200 (e.g., the at least one of the one or more apertures 208 is the first to deform). In some embodiments, the one or more apertures 208 are configured to assist the crush tube 200 in crushing progressively during impact, so as to increase an energy amount absorbable by the crush tube 200.

In some embodiments, the one or more apertures 208 may be defined by the same diameter. In other embodiments, the one or more apertures 208 are defined by diameters and configured in descending diameter order from the first end 202 to the second end 204 of the crush tube 200. For example, the one or more apertures 208 can include (i) a first aperture disposed proximate to the first end 202 of the crush tube 200 and defined by a first diameter and (ii) a second aperture disposed between the first aperture and the second end 204 of the crush tube 200 and defined by a second diameter, where the first diameter is larger than the second diameter.

In some examples, the descending diameter order may configure the crush tube 200 to have descending structural strength in a direction from the first end 202 to the second end 204 of the crush tube 200, such that the crush tube 200 is less resistant to crushing proximate to the first end 202 compared to proximate the second end 204. The descending structural strength may allow the crush tube 200 to absorb energy via crushing proximate to the first end 202 while also maintaining structural integrity and reducing crushing proximate to the second end 204 to minimize or prevent deformation of other components coupled to the second end 204 of the crush tube 200 or the front skateboard structure 100. In some embodiments, the descending diameter order is a linear descending diameter order. For example, a first aperture of the one or more apertures 208 is defined by a diameter of approximately 18 mm, a second aperture of the one or more apertures 208 is defined by a diameter of approximately 16 mm, a third aperture of the one or more apertures 208 is defined by a diameter of approximately 14 mm, a fourth aperture of the one or more apertures 208 is defined by a diameter of approximately 12 mm, a fifth aperture of the one or more apertures 208 is defined by a diameter of approximately 10 mm, etc. In some embodiments, the descending diameter order is an exponential descending diameter order. It should be appreciated that the foregoing diameters are merely exemplary and other sizing may be used.

In some embodiments, the one or more apertures 208 are defined by diameters and configured in ascending diameter order from the first end 202 to the second end 204 of the crush tube 200. For example, the one or more apertures 208 can include (i) a third aperture disposed proximate to the first end 202 of the crush tube 200 and defined by a third diameter and (ii) a fourth aperture disposed between the third aperture and the second end 204 of the crush tube 200 and defined by a second diameter, where the third diameter is smaller than the fourth diameter. In some embodiments, the one or more apertures 208 is defined by a diameter with a range between approximately 5 mm and approximately 25 mm (e.g., 11 mm, 24 mm, etc.). In some embodiments, the one or more apertures 208 is defined by a diameter with a range between approximately 10 mm and approximately 18 mm (e.g., 12 mm, 15 mm, etc.) In some embodiments, the one or more apertures 208 include one aperture 208, five apertures 208, six apertures 208, or the like.

In some embodiments, diameters defining the one or more apertures 208 on a first main sidewall of the main sidewalls 206 are different from diameters defining the one or more apertures 208 on a second main sidewall of the main sidewalls 206. In other embodiments, the diameters defining the one or more apertures 208 on the first main sidewall of the main sidewalls 206 are the same as the diameters defining the one or more apertures 208 on the second main sidewall of the main sidewalls 206. In some embodiments, a combination of the constant thickness of the main sidewalls 206 and the descending diameter order of the one or more apertures 208 provides energy absorption while engaging all contours (e.g., bent portions) of the crush tube 200.

The crush tube 200 further includes a plurality of auxiliary sidewalls 210 extending from the first end 202 to the second end 204. Each of the auxiliary sidewalls 210 is coupled between two main sidewalls of the main sidewalls 206. In some embodiments, the auxiliary sidewalls 210 are smooth. In other embodiments, the auxiliary sidewalls 210 are textured. For example, the auxiliary sidewalls 210 may include structural features disposed along a length of the auxiliary sidewalls 210. In some embodiments, the auxiliary sidewalls 210 are substantially flat. In other embodiments, the auxiliary sidewalls 210 are curved. For example, the auxiliary sidewalls 210 may include a semi-circular cross-section. In some embodiments, the auxiliary sidewalls 210 include two auxiliary sidewalls 210, four auxiliary sidewalls 210, seven auxiliary sidewalls 210, or the like. In some embodiments, the auxiliary sidewalls 210 include a constant thickness along a length of the auxiliary sidewalls 210. In other embodiments, the auxiliary sidewalls 210 include a varying thickness along the length of the auxiliary sidewalls 210. In some embodiments, an auxiliary sidewall thickness of the auxiliary sidewalls 210 is between approximately 1.5 mm to approximately 3.5 mm. For example, the auxiliary sidewall thickness is approximately 2.5 mm, approximately 2.86 mm, approximately 3.01 mm, or the like. Other dimensions may be utilized in alternative embodiments. In some embodiments, the main sidewalls 206 are manufactured from a first material and the auxiliary sidewalls 210 are manufactured from a second material, where the first material and the second material are different. In other embodiments, the main sidewalls 206 and the auxiliary sidewalls 210 are manufactured from the same material.

In some embodiments, at least two of the main sidewalls 206 include different lengths. For example, a third main sidewall of the main sidewalls 206 includes a length that is longer than a length of a fourth main sidewall of the main sidewalls 206. In some examples, the fourth main sidewall opposes the third main sidewall. In other examples, the fourth main sidewall does not oppose the third main sidewall. In some embodiments, the crush tube 200 comprises a first interface plane disposed proximate the first end 202 of the crush tube 200 is angled relative to a second interface plane of the crush tube 200 that is disposed proximate the second end 204 of the crush tube 200. In some examples, the first interface plane is flush with the first end 202 of the crush tube 200 and/or the second interface plane is flush with the second end 204 of the crush tube 200. In some embodiments, the first interface plane is angled relative to the second interface plane at the angle A1. In some embodiments, at least two of the auxiliary sidewalls 210 include different lengths.

The crush tube 200 may be manufactured via a method described herein. At a first step, a flat piece of sheet metal may be provided, without the one or more apertures 208 defined thereon. In some embodiments, more than one flat piece of sheet metal is provided. At a second step, the sheet metal may be sequentially bent. For example, in some embodiments, the sheet metal is bent starting from one end of the sheet metal, working towards an opposing end of the sheet metal. More specifically, the sheet metal is bent to form a substantially octagonal shape. Additionally or alternatively, the sheet metal is rolled as to form a substantially annular tubular member. At a third step, the sheet metal may be welded. For example, once the sheet metal is bent, where the one end (e.g., a first end) of the sheet metal abuts the opposing end (e.g., a second end) of the sheet metal, a weld is positioned between the first end and the second end of the sheet metal to couple the first end and the second end of the sheet metal. The weld may be a single seam weld to hold the octagonal shape. In some embodiments, a bracket may be fastened between the first end and the second end of the sheet metal to hold the octagonal shape. In other embodiments, no weld or bracket may be provided between the first end and the second end of the sheet metal. At a fourth step, the one or more apertures 208 are formed via laser cutting. For example, the one or more apertures 208 are laser cut out of the crush tube 200. The laser cutting may occur in a sequential order moving down the length of the crush tube 200. The laser cutting from one side of the crush tube 200 may form the one or more apertures 208 on an opposing side of the crush tube 200. Additionally or alternatively, the one or more apertures 208 may be formed via machining operations, such as a computer numerical control (CNC) machine, drill press, or the like. At a fifth step, another of the one or more apertures 208 are formed via laser cutting, where the same process as described above in reference to the one or more apertures 208 is provided onto another side of the crush tube 200. For example, the crush tube 200 is rotated onto a clean surface where the laser cutting process begins again to form the one or more apertures 208 onto other one or more main sidewalls 206 of the crush tube 200. Although this description may discuss a specific order of method steps, the order of steps may differ from what is outlined. Also, two or more steps may be performed concurrently or with partial concurrence. Furthermore, various steps may be added or omitted in certain embodiments.

As illustrated in FIGS. 3-5, each of the front energy absorbing assemblies 108 further includes a fixed mount bracket 212 coupled to the crush tube 200. In some embodiments, the fixed mount bracket 212 is coupled to the crush tube 200 proximate to the first end 202. In some embodiments, the fixed mount bracket 212 is coupled to the crush tube 200 proximate to the second end 204.

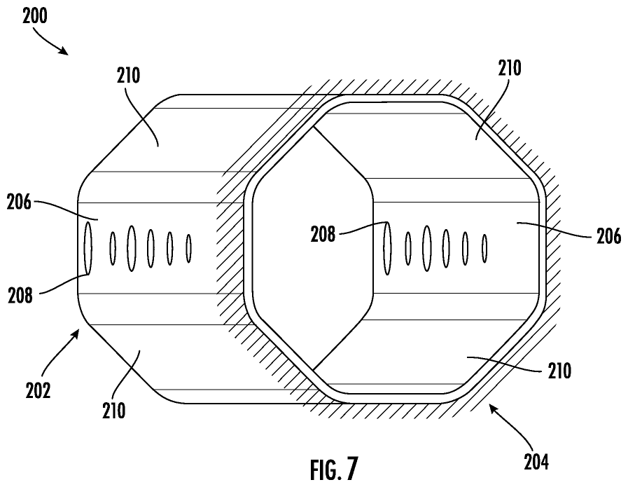

As illustrated in FIGS. 3-5 and 8, the fixed mount bracket 212 includes a platform 214 disposed proximate a top portion of the fixed mount bracket 212. The fixed mount bracket 212 further includes one or more side panels 216 extending downward from the platform 214. Each of the one or more side panels 216 is configured to contact one of the main sidewalls 206. In some embodiments, each of the one or more side panels 216 includes welded portions 218 that are configured to be welded to a corresponding one of the main sidewalls 206, thereby coupling a respective one of the one or more side panels 216 to the corresponding one of the main sidewalls 206. In some embodiments, a location of the welded portions 218 is configured to prevent or minimize the one or more side panels 216 and/or the fixed mount bracket 212 from hindering the crush tube 200 from deforming upon impact.

In some embodiments, the one or more side panels 216 includes one side panel 216, two side panels 216, five side panels 216, or the like. In some embodiments, each of the one or more side panels 216 is configured to contact one of the auxiliary sidewalls 210. In some embodiments, each of the one or more side panels 216 is coupled to one of the auxiliary sidewalls 210. In some embodiments, the one or more side panels 216 include a thickness that is equal to, or approximately equal to, a thickness of the main sidewalls 206 and/or the auxiliary sidewalls 210. In other embodiments, the thickness of the one or more side panels 216 is less than the thickness of the main sidewalls 206 and/or the auxiliary sidewalls 210. In some examples, the relatively small thickness of the one or more side panels 216 permits at least a portion of the one or more side panels 216 to be crushed when the crush tube 200 is crushed upon impact. Such crushing upon impact avoids the one or more side panels 216 from hindering crushing of the crush tube 200 proximate to the one or more side panels 216.

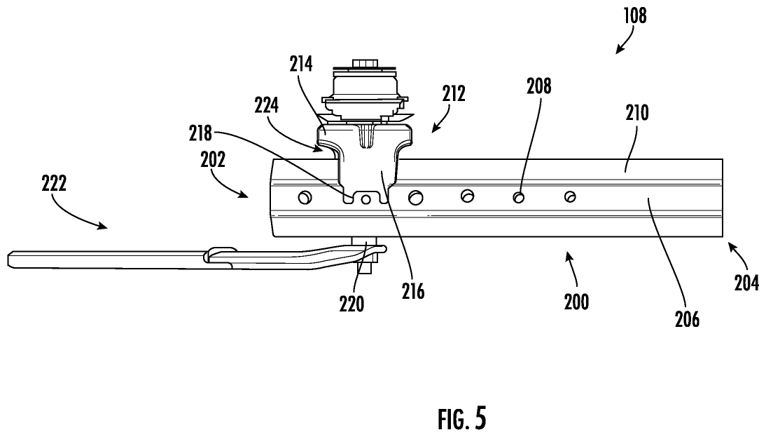

The fixed mount bracket 212 further includes a connector 220 extending downward from the platform 214. As illustrated in FIG. 6, the one or more apertures 208 may include at least one connector aperture 221 that is configured to receive the connector 220. In some embodiments, the at least one connector aperture 221 includes two connector apertures 221 disposed within two opposing main sidewalls 206. In some embodiments, the at least one connector aperture 221 is defined by a larger diameter than the diameters of the other one or more apertures 208 (e.g., one or more apertures 208 that are not the at least one connector aperture 221). In some embodiments, a diameter of the at least one connector aperture 221 corresponds to the diameters of the other one or more apertures 208 as disclosed herein (e.g., the one or more apertures 208 being defined by equal diameters, descending diameter order, ascending diameter order, etc.). In some embodiments, as illustrated in FIG. 5, the connector 220 is configured to receive a tow hook 222. The tow hook 222 may be coupled to an object external to the vehicle. In some embodiments, the tow hook 222 is configured to apply a force to the connector 220 in a force direction defined as a direction from the second end 204 to the first end 202 of the crush tube 200, such that that the tow hook 222 applies a tensile force to the crush tube 200 (e.g., not a compressive force).

In some embodiments, the fixed mount bracket 212 is coupled to the crush tube 200 such that a gap 224 is disposed between the platform 214 and at least one main sidewall of the main sidewalls 206 and/or at least one auxiliary sidewall of the auxiliary sidewalls 210. The gap 224 may permit the crush tube 200 to be crushed upon impact proximate to the platform 214, thereby preventing the platform 214 from hindering a crushing of the crush tube 200 proximate to the platform 214. In some embodiments, the platform 214 is configured to couple to body components of the vehicle such that the fixed mount bracket 212 couples the body components to the front skateboard structure 100 or the frame 101.

### III. Overview of Example Side Skateboard Structure

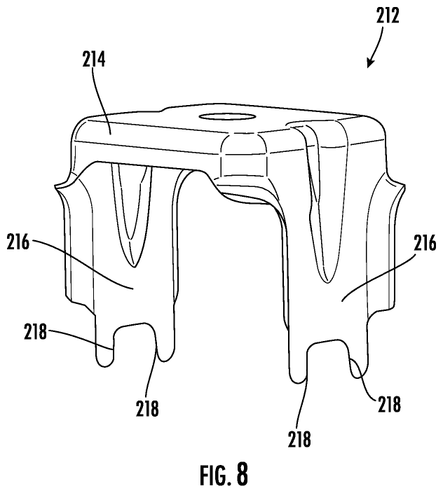

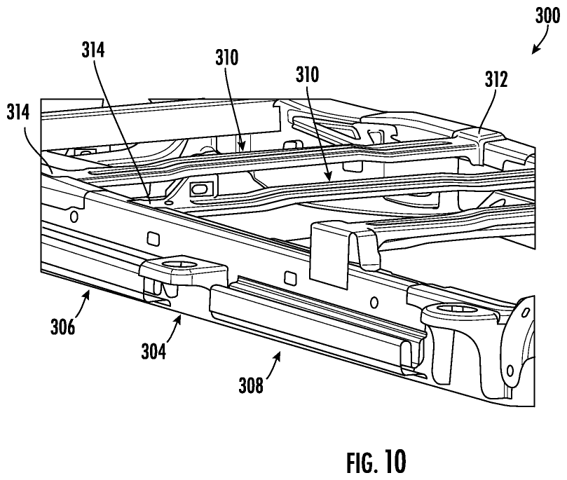

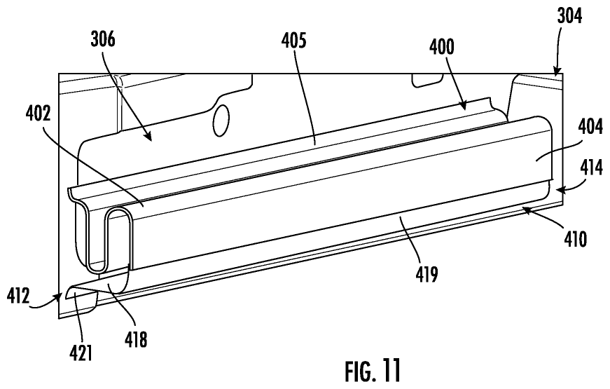

FIGS. 9, 10, 12, and 13 illustrate various embodiments of a side skateboard structure 300 configured to be disposed proximate to a central portion and/or a rear portion of the vehicle. In some embodiments, the side skateboard structure 300 is disposed proximate to the front portion of the vehicle. The side skateboard structure 300 may be coupled to the frame 101. In some embodiments, the side skateboard structure 300 is coupled to a central portion or the rear portion of the frame 101. In other embodiments, the side skateboard structure 300 is coupled to the front portion of the frame 101. The side skateboard structure 300 is configured to absorb energy generated from a side impact between the vehicle and the external object to reduce transfer of energy to the passenger compartment of the vehicle and/or other components of the vehicle.

The frame 101 may include a first frame side 302 and a second frame side 304 opposing the first frame side 302. The side skateboard structure 300 may include first side energy absorbing assemblies 306. In some embodiments, the first side energy absorbing assemblies 306 include two first side energy absorbing assemblies 306, where (i) one first side energy absorbing assembly 306 is disposed at the first frame side 302 proximate to the central portion of the frame 101, and (ii) one first side energy absorbing assembly 306 is disposed at the second frame side 304 proximate to the central portion of the frame 101. The side skateboard structure 300 may further include second side energy absorbing assemblies 308. In some embodiments, the second side energy absorbing assemblies 308 include two second side energy absorbing assemblies 308, where (i) one second side energy absorbing assembly 308 is disposed at the first frame side 302 proximate to the rear portion of the frame 101, and (ii) one second side energy absorbing assembly 308 is disposed at the second frame side 304 proximate to the rear portion of the frame 101. In some embodiments, at least one of the first side energy absorbing assemblies 306 and at least one of the second side energy absorbing assemblies 308 are equal, or approximately equal, in dimensions (e.g., height, length, width, etc.). In other embodiments, a length of at least one of the first side energy absorbing assemblies 306 is shorter than a length of at least one of the second side energy absorbing assemblies 308. In yet other embodiments, the length of the at least one of the first side energy absorbing assemblies 306 is longer than the length of the at least one of the second side energy absorbing assemblies 308. In some embodiments, the length of the at least one of the first side energy absorbing assemblies 306 is equal to a length of a front door and/or a front seat of the vehicle. In some embodiments, the length of the at least one of the second side energy absorbing assemblies 308 is equal to a length of a rear door and/or a rear seat of the vehicle.

The side skateboard structure 300 further includes one or more crossbars 310 extending between the first frame side 302 and the second frame side 304. The one or more crossbars 310 is configured to provide structural support to the frame 101 and minimize deformation of the first frame side 302 to the second frame side 304 and deformation of the second frame side 304 to the first frame side 302. In some embodiments, the one or more crossbars 310 include (i) a first crossbar disposed proximate to the front portion and/or the central portion of the frame 101 such that the first crossbar is configured to minimize deformation of the first frame side 302 to the second frame side 304 and deformation of the second frame side 304 to the first frame side 302 proximate to the front portion and/or the central portion of the frame 101 and (ii) a second crossbar disposed proximate to the central portion and/or the rear portion of the frame 101 such that the second crossbar is configured to minimize deformation of the first frame side 302 to the second frame side 304 and deformation of the second frame side 304 to the first frame side 302 proximate to the central portion and/or the rear portion of the frame 101.

The one or more crossbars 310 includes (i) a first crossbar end 312 coupled to the first frame side 302, and (ii) a second crossbar end 314 opposing the first crossbar end 312 and coupled to the second frame side 304. In some embodiments, the first crossbar end 312 is coupled to a top portion of the first frame side 302 and/or the second crossbar end 314 is coupled to a top portion of the second frame side 304. In some examples, coupling the first crossbar end 312 to the top portion of the first frame side 302 and/or the second crossbar end 314 to the top portion of the second frame side 304 increases a storage volume located below the one or more crossbars 310. In some embodiments, the storage volume is configured to receive the battery. In some embodiments, the one or more crossbars 310 includes an upward step 316 disposed between the first crossbar end 312 and the second crossbar end 314 and that extends above the first crossbar end 312 and the second crossbar end 314. In some examples, the upward step 316 is configured to prevent or minimize the one or more crossbars 310 from bending downward upon deformation that is caused by an impact. In some embodiments, preventing or minimizing the one or more crossbars 310 from bending downward prevents or minimizes the one or more crossbars 310 from contacting or deforming a battery located below the one or more crossbars 310 and between the first frame side 302 and the second frame side 304.

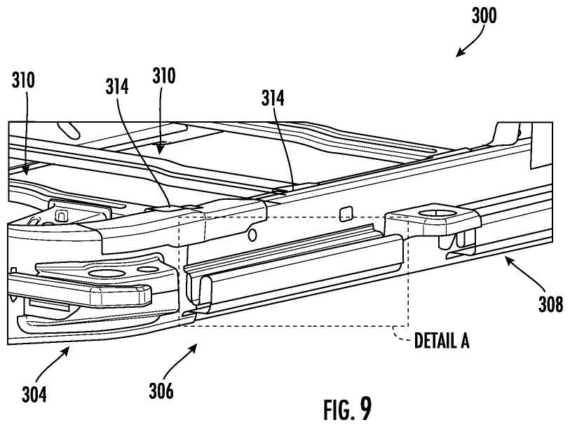

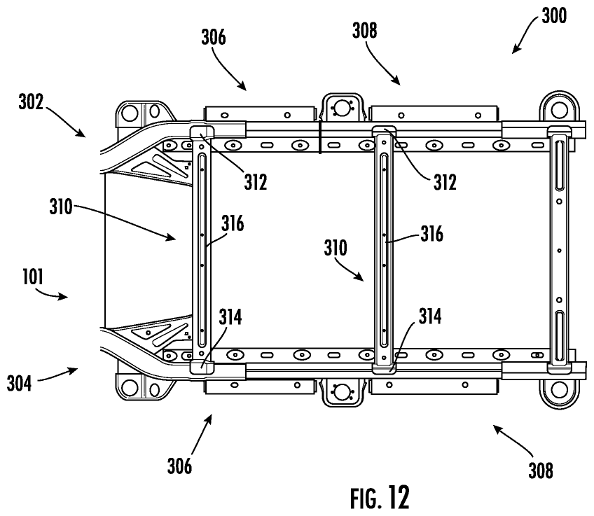

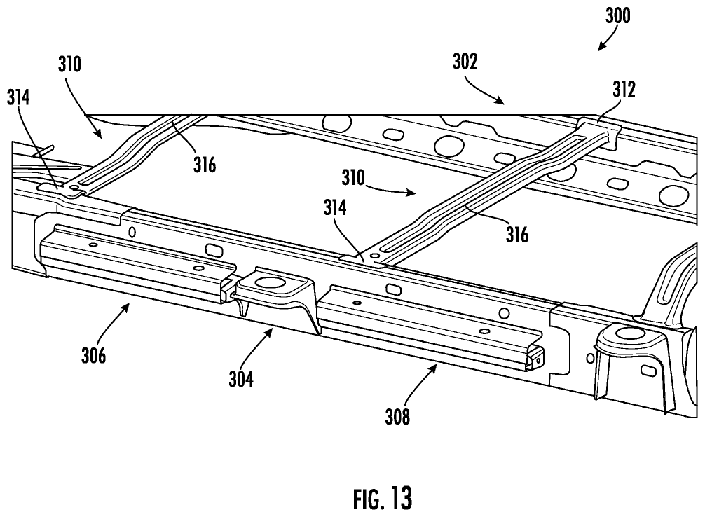

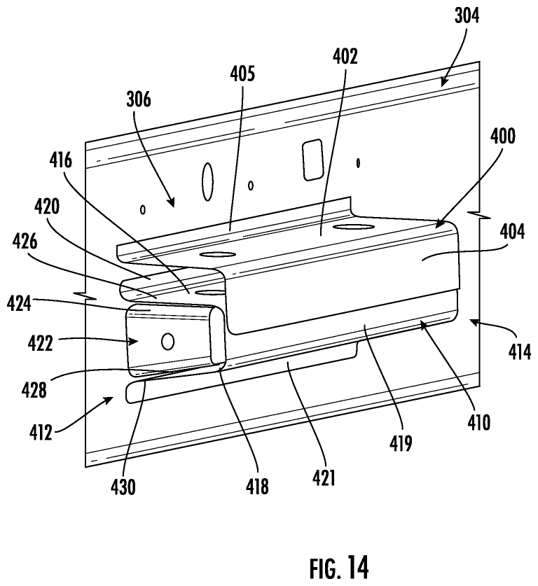

FIGS. 11 and 14-19 illustrate various embodiments of one of the first side energy absorbing assemblies 306 (e.g., the first side energy absorbing assembly 306). It is to be appreciated that the description disclosed herein for the first side energy absorbing assembly 306 may apply to all of the first side energy absorbing assemblies 306 and/or all of the second side energy absorbing assemblies 308. The first side energy absorbing assembly 306 includes a first bracket 400. In some embodiments, as shown in FIG. 11, the first bracket 400 includes an S-shaped cross-section. In other embodiments, as shown in FIGS. 14-19, the first bracket 400 includes an L-shaped cross-section. In yet other embodiments, the first bracket 400 includes an C-shaped, a U-shaped, or the like, cross-section. The first bracket 400 includes a first bracket upper surface 402 disposed proximate an upper portion of the first bracket 400. In some embodiments, as shown in FIG. 11, the first bracket upper surface 402 includes an s-shaped cross-section. For example, the first bracket upper surface 402 includes a serpentine or a sinuous shape cross-section. In some embodiments, the s-shaped, the serpentine shape, and/or the sinuous shape cross-sections are achieved by a plurality of bends. In some examples, the first bracket upper surface 402 includes two bends. In other examples, the first bracket upper surface 402 includes less than two bends (e.g., one bend, no bend, etc.) or more than two bends (e.g., three bends, five bends, etc.). The plurality of bends may be in equal and/or opposite directions. In some embodiments, one or more bends of the plurality of bends include an angle between approximately 0 degrees and approximately 90 degrees. In other embodiments, the one or more bends include the angle between approximately 90 degrees and 180 degrees. In yet other embodiments, the one or more bends include the angle between approximately 180 degrees and approximately 270 degrees. In yet other embodiments, the one or more bends include the angle between approximately 270 degrees and approximately 360 degrees. In yet other embodiments, the one or more bends include the angle less than approximately 0 degrees or more than approximately 360 degrees. The first bracket 400 further includes a first bracket side surface 404 extending downward from the first bracket upper surface 402. The first bracket 400 may further include a flange 405 opposing the first bracket side surface 404 and extending upward from the first bracket upper surface 402. In some arrangements, the flange 405 is coupled to the second frame side 304 and/or the frame 101 such that the first bracket 400 is coupled to the second frame side 304 and/or the frame 101. In some examples, the flange 405 is coupled to the second frame side 304 and/or the frame 101 via welding, adhesive, and/or the like.

The first side energy absorbing assembly 306 further includes a second bracket 410 disposed proximate to a lower portion of the first bracket 400. In some embodiments, as shown in FIG. 11, the second bracket 410 includes an L-shaped cross-section. In other embodiments, as shown in FIGS. 14-19, the second bracket 410 includes a C-shaped or a D-shaped cross-section. In yet other embodiments, the second bracket 410 includes a T-shaped, a U-shaped, or the like, cross-section. The second bracket 410 includes a first end 412 and a second end 414 opposing the first end 412. In some embodiments, a distance between the first end 412 and the second end 414 of the second bracket 410 is equal to, or approximately equal to, a length of the first bracket 400. In other embodiments, the distance between the first end 412 and the second end 414 of the second bracket 410 is less than or more than the length of the first bracket 400. In some embodiments, as shown in FIGS. 14-19, The second bracket 410 further includes a second bracket upper surface 416 disposed proximate an upper portion of the second bracket 410 and extending between the first end 412 and the second end 414 of the second bracket 410.

As shown in FIGS. 11 and 14-19, the second bracket 410 further includes a second bracket lower surface 418 disposed proximate a lower portion of the second bracket 410 and extending between the first end 412 and the second end 414 of the second bracket 410. In some embodiments, as shown in FIGS. 14-19, the second bracket lower surface 418 is disposed opposite the second bracket upper surface 416. The second bracket 410 further includes a second bracket side surface 419 extending upward from the second bracket lower surface 418 and extending between the first end 412 and the second end 414 of the second bracket 410. In some embodiments, as shown in FIGS. 14-19, the second bracket side surface 419 extends between the second bracket upper surface 416 and the second bracket lower surface 418. In some embodiments, at least a portion of the second bracket side surface 419 is coupled to at least a portion of the first bracket side surface 404. In some examples, the at least the portion of the second bracket side surface 419 is coupled to the at least the portion of the first bracket side surface 404 via a weld, adhesive, fasteners, and/or the like. In some embodiments, the at least the portion of the second bracket side surface 419 is in contact with, but not fixed relative to, the at least the portion of the first bracket side surface 404.

In some embodiments, as shown in FIGS. 14-19, the second bracket 410 may include an upper flange 420 opposing the second bracket side surface 419 and extending upward from the second bracket upper surface 416. In some arrangements, the upper flange 420 is coupled to the second frame side 304 and/or the frame 101 such that at least a portion of the second bracket 410 is coupled to the second frame side 304 and/or the frame 101. In some examples, the upper flange 420 is coupled to the second frame side 304 and/or the frame 101 via welding, adhesive, and/or the like. In some embodiments, as shown in FIGS. 11 and 14-19, the second bracket 410 may include a lower flange 421 opposing the second bracket side surface 419 and extending downward from the second bracket lower surface 418. In some arrangements, the lower flange 421 is coupled to the second frame side 304 and/or the frame 101 such that at least a portion of the second bracket 410 is coupled to the second frame side 304 and/or the frame 101. In some examples, the lower flange 421 is coupled to the second frame side 304 and/or the frame 101 via welding, adhesive, and/or the like.

As shown in FIGS. 14-19, the first side energy absorbing assembly 306 may further include a first side bracket 422 disposed proximate the first end 412 of the second bracket 410. In some embodiments, the first side bracket 422 includes a first side bracket portion 424 coupled to a first portion 426 of the second bracket upper surface 416. In some examples, the first side bracket portion 424 is coupled to the first portion 426 of the second bracket upper surface 416 via a weld, adhesive, fasteners, and/or the like. In some embodiments, the first side bracket portion 424 is in contact with, but not fixed relative to, the first portion 426 of the second bracket upper surface 416. In some embodiments, the first side bracket 422 further includes a second side bracket portion 428 coupled to a first portion 430 of the second bracket lower surface 418. In some examples, the second side bracket portion 428 is coupled to the first portion 430 of the second bracket lower surface 418 via a weld, adhesive, fasteners, and/or the like. In some embodiments, the second side bracket portion 428 is in contact with, but not fixed relative to, the first portion 430 of the second bracket lower surface 418.

The first side energy absorbing assembly 306 may further include a second side bracket (not shown) disposed proximate the second end 414 of the second bracket 410. The second side bracket may include an equivalent appearance to the first side bracket 422, as shown in FIGS. 14-19. In some embodiments, the second side bracket includes a third side bracket portion coupled to a second portion of the second bracket upper surface 416. In some examples, the third side bracket portion is coupled to the second portion of the second bracket upper surface 416 via a weld, adhesive, fasteners, and/or the like. In some embodiments, the third side bracket portion is in contact with, but not fixed relative to, the second portion of the second bracket upper surface 416. In some embodiments, the second side bracket includes a fourth side bracket portion coupled to a second portion of the second bracket lower surface 418. In some examples, the fourth side bracket portion is coupled to the second portion of the second bracket lower surface 418 via a weld, adhesive, fasteners, and/or the like. In some embodiments, the fourth side bracket portion is in contact with, but not fixed relative to, the second portion of the second bracket lower surface 418.

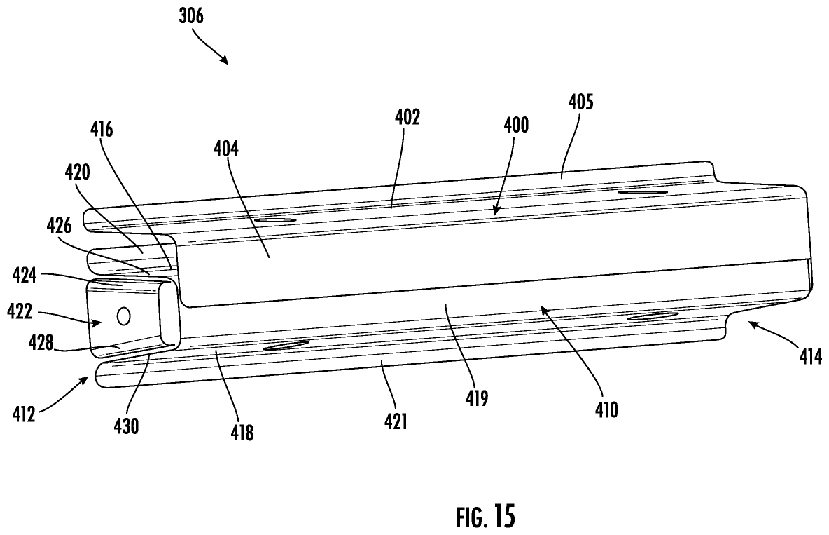

FIGS. 17-19 illustrate the first side energy absorbing assembly 306 and an external object 450. In some embodiments, the external object 450 is a rigid object (e.g., body, etc.), such that deformation of the external object 450 is small, minimal, or negligible, relative to deformation of the first side energy absorbing assembly 306 after contact with the external object 450. In some embodiments, the external object 450 is a semi-rigid object, such that deformation of the external object 450 is less than, equal to, approximately equal to, or more than the deformation of the first side energy absorbing assembly 306 after contact with the external object 450. In some examples, the external object 450 is a component (e.g., bumper, door, etc.) of an external vehicle, a light pole, a traffic light post, a sign post, a part of a building (e.g., house, residential building, commercial building, etc.), or the like.

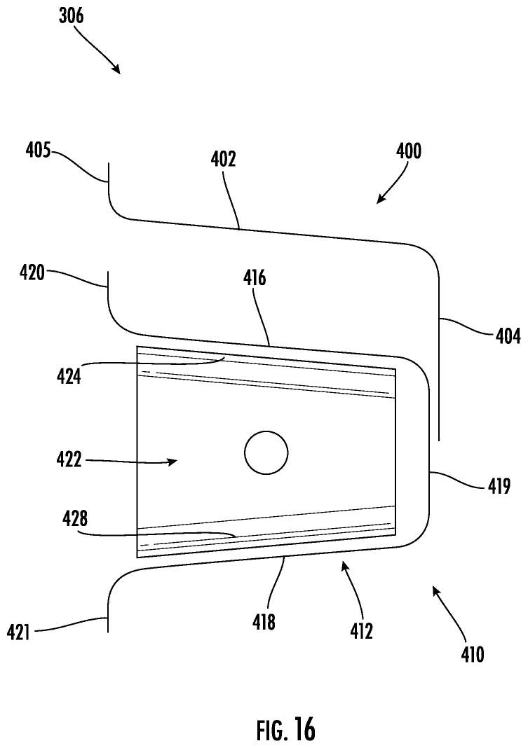

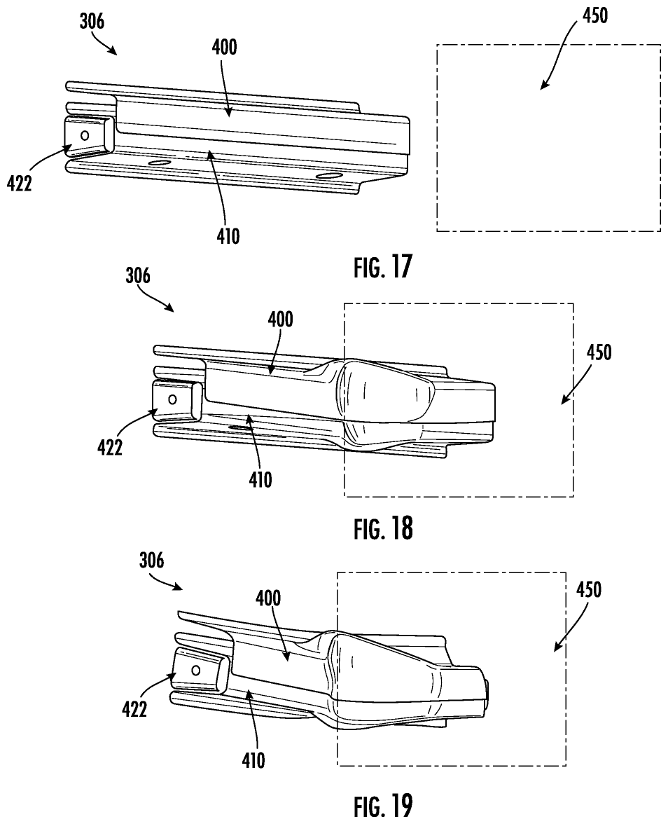

FIG. 17 illustrates the first side energy absorbing assembly 306 and the external object 450 before making contact, such that the first side energy absorbing assembly 306 is not deformed (e.g., undeformed, unbent, etc.). FIG. 18 illustrates the first side energy absorbing assembly 306 and the external object 450 after making partial contact, such that the first side energy absorbing assembly 306 is partially deformed. FIG. 19 illustrates the first side energy absorbing assembly 306 and the external object 450 after making full contact, such that the first side energy absorbing assembly 306 is fully, or approximately fully, deformed. As shown in FIGS. 18 and 19, the first side bracket 422 and/or the second side bracket are configured to prevent or minimize a match boxing effect of the first side energy absorbing assembly 306, where the first side energy absorbing assembly 306 deforms in a vertical direction (e.g., in a direction from the first bracket upper surface 402 to the second bracket lower surface 418 or from the second bracket lower surface 418 to the first bracket upper surface 402). The first side bracket 422 and/or the second side bracket maintain, or approximately maintain, a cross-sectional structure of the first side energy absorbing assembly 306 proximate the first end 412 and/or the second end 414 of the second bracket 410. By maintaining, or approximately maintaining, the cross-sectional structure of the first side energy absorbing assembly 306, the first side energy absorbing assembly 306 crushes inward progressively upon impact with the external object 450, thereby increasing an amount of energy absorbed by the first side energy absorbing assembly 306 on impact with the external object 450.

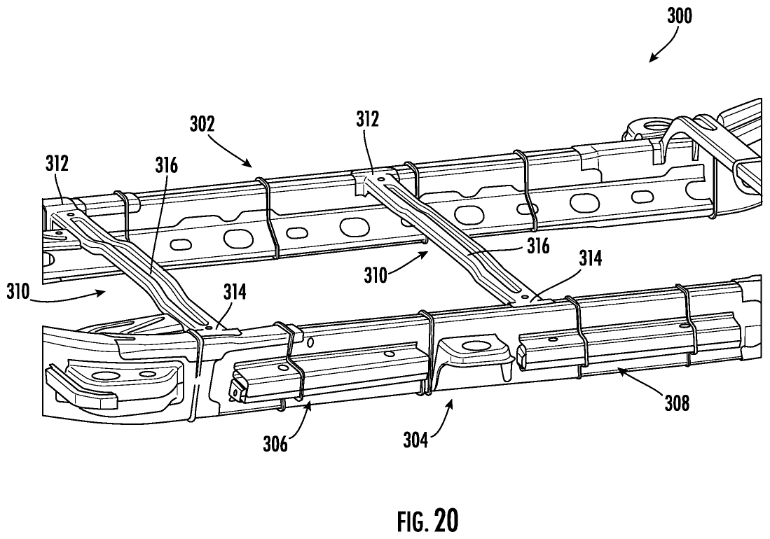

FIG. 20 corresponds to FIG. 17 and illustrates the side skateboard structure 300 before impact with the external object 450, such that the side skateboard structure 300 is undeformed. More specifically, the side skateboard structure 300 is undeformed such that the first side energy absorbing assemblies 306, the second side energy absorbing assemblies 308, and the one or more crossbars 310 are undeformed.

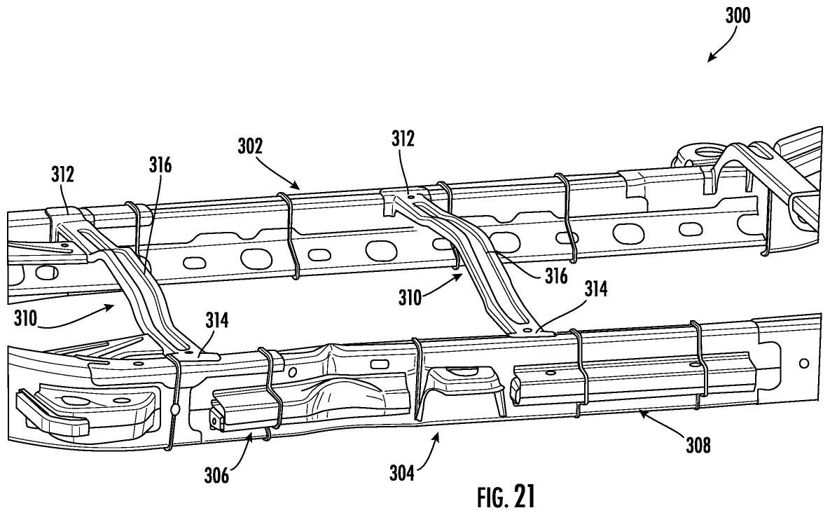

FIG. 21 corresponds to FIG. 19 and illustrates the side skateboard structure 300 after full contact with the external object 450, such that the side skateboard structure 300 is deformed. More specifically, the side skateboard structure 300 is deformed such that (i) at least one of the one or more crossbars 310 is deformed, and (ii) at least one of the first side energy absorbing assemblies 306 or at least one of the second side energy absorbing assemblies 308 is deformed. As shown in FIG. 21, the upward step 316 of the one or more crossbars 310 prevents the one or more crossbars 310 from bending downward or reduces (e.g., minimizes) the extent of bending.

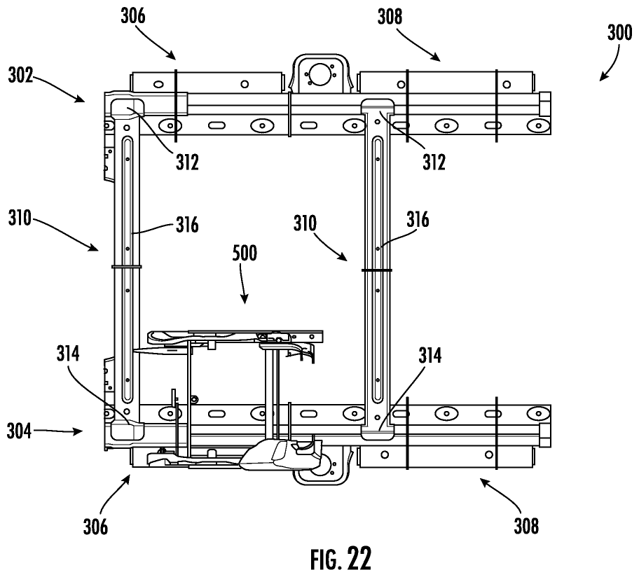

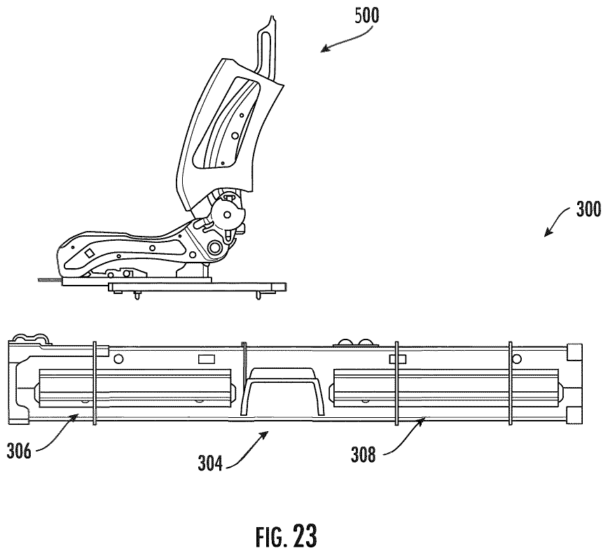

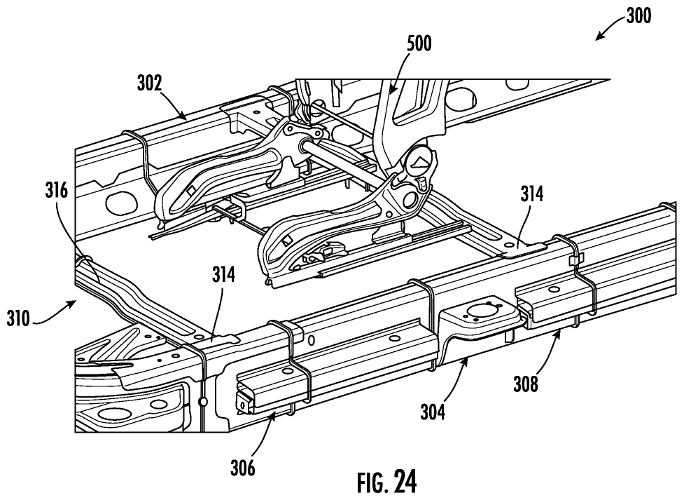

FIGS. 22-24 illustrate the side skateboard structure 300 and a seat assembly 500. In some embodiments, the seat assembly 500 is coupled to the body of the vehicle that is coupled to the frame 101 and/or the side skateboard structure 300. As shown in FIGS. 22 and 23, a lateral location of one of the first side energy absorbing assembly 306 is aligned with, or approximately aligned with, a lateral location of the seat assembly 500, such that the corresponding first side energy absorbing assembly 306 is configured to absorb energy from impact to minimize energy absorbed by the seat assembly 500.

### IV. Configuration of Example Embodiments

As utilized herein, the terms “approximately”, “about”, “substantially”, and similar terms are intended to have a broad meaning in harmony with the common and accepted usage by those of ordinary skill in the art to which the subject matter of this disclosure pertains, and are generally understood to include a variation within about plus or minus 5% or 10% of any stated value. Unless otherwise indicated, all numbers expressing quantities of properties, parameters, conditions, and so forth, used in the specification and claims are to be understood as being modified in all instances by the term “about” or “approximately.” It should be understood by those of skill in the art who review this disclosure that these terms are intended to allow a description of certain features and claimed without restricting the scope of these features to the precise numerical ranges provided. Accordingly, these terms should be interpreted as indicating that insubstantial or inconsequential modification or alterations of the subject matter described and claimed are considered to be within the scope of the invention as recited in the appended claims.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

It should be noted that the term “example” as used herein to describe various embodiments is intended to indicate that such embodiments are possible examples, representations, and/or illustrations of possible embodiments.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter described herein. Other substitutions, modifications, changes and omissions may also be made in the design, assembly and arrangement of the various exemplary embodiments without departing from the scope of the embodiments described herein. While this specification contains implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A front energy absorbing assembly for use in a front skateboard structure of an electric pickup vehicle, the front energy absorbing assembly comprising:
a fixed mount bracket comprising:
a platform, and
a connector extending downward from the platform; and
a crush tube comprising:
a plurality of main sidewalls, each of the main sidewalls comprising one or more apertures, and
a plurality of auxiliary sidewalls, each of the auxiliary sidewalls coupled between two main sidewalls of the plurality of main sidewalls,
wherein the connector is configured to be received within at least one of the one or more apertures.

2. The front energy absorbing assembly of claim 1, wherein:
the fixed mount bracket further comprises one or more side panels extending downward from the platform; and
at least a portion of the one or more side panels is coupled to at least one of a main sidewall of the plurality of main sidewalls or an auxiliary sidewall of the plurality of auxiliary sidewalls.

3. The front energy absorbing assembly of claim 2, wherein the at least the portion of the one or more side panels is welded to the at least one of the main sidewall or the auxiliary sidewall.

4. The front energy absorbing assembly of claim 1, wherein:
the plurality of main sidewalls comprises four main sidewalls;
the plurality of auxiliary sidewalls comprises four auxiliary sidewalls; and
the crush tube comprises an octagonal cross-section.

5. The front energy absorbing assembly of claim 1, wherein:
the crush tube further comprises a first end and a second end;
the one or more apertures comprise a first aperture defined by a first diameter and a second aperture defined by a second diameter, the first diameter being larger than the second diameter;
the first aperture is disposed proximate to the first end; and
the second aperture is disposed between the first aperture and the second end.

6. The front energy absorbing assembly of claim 5, wherein the first diameter and the second diameter are between 10 mm and 18 mm.

7. The front energy absorbing assembly of claim 5, wherein the one or more apertures further comprise a third aperture, a fourth aperture, a fifth aperture, and a sixth aperture.

8. The front energy absorbing assembly of claim 1, wherein:
the plurality of main sidewalls comprise a first main sidewall and a second main sidewall;
the first main sidewall comprises a first length;
the second main sidewall comprises a second length;
the first length is longer than the second length;
the crush tube comprises:
a first end,
a second end opposing the first end,
a first interface plane disposed proximate the first end, and
a second interface plane disposed proximate the second end; and
the first interface plane is angled relative to the second interface plane.

9. A side skateboard structure for use in a vehicle, the side skateboard structure comprising:
a frame comprising:
a first frame side, and
a second frame side opposing the first frame side; and
one or more side energy absorbing assemblies disposed along at least one of the first frame side or the second frame side, each of the side energy absorbing assemblies comprising:
a first bracket comprising:
a first bracket upper surface, and
a first bracket side surface extending downward from the first bracket upper surface;
a second bracket comprising:
a first end,
a second end opposing the first end,
a second bracket upper surface extending between the first end and the second end,
a second bracket lower surface extending between the first end and the second end and opposing the second bracket upper surface, and
a second bracket side surface extending between the first end and the second end and extending between the second bracket upper surface and the second bracket lower surface, wherein at least a portion of the second bracket side surface is coupled to at least a portion of the first bracket side surface;
a first side bracket disposed at the first end, the first side bracket comprising:
a first side bracket portion coupled to a first portion of the second bracket upper surface, and
a second side bracket portion coupled to a first portion of the second bracket lower surface; and
a second side bracket disposed at the second end, the second side bracket comprising:
a third side bracket portion coupled to a second portion of the second bracket upper surface, and
a fourth side bracket portion coupled to a second portion of the second bracket lower surface.

10. The side skateboard structure of claim 9, further comprising one or more crossbars extending between the first frame side and the second frame side, the one or more crossbars comprising:
a first crossbar end coupled to the first frame side; and
a second crossbar end opposing the first end and coupled to the second frame side,
wherein the one or more crossbars comprises an upward step disposed between the first crossbar end and the second crossbar end, the upward step extends above the first crossbar end and the second crossbar end.

11. The side skateboard structure of claim 9, wherein the one or more side energy absorbing assemblies comprise two side energy absorbing assemblies disposed along the first frame side and two side energy absorbing assemblies disposed along the second frame side.

12. The side skateboard structure of claim 9, wherein:
the one or more side energy absorbing assemblies comprise a first side energy absorbing assembly and a second side energy absorbing assembly;
the first side energy absorbing assembly comprising a first length;
the second side energy absorbing assembly comprising a second length; and
the second length is longer than the first length.

13. The side skateboard structure of claim 9, wherein:
the at least the portion of the second bracket side surface is welded to the at least the portion of the first bracket side surface;
the first side bracket portion is welded to the first portion of the second bracket upper surface;
the second side bracket portion is welded to the first portion of the second bracket lower surface;
the third side bracket portion is welded to the second portion of the second bracket upper surface; and
the fourth side bracket portion is welded to the second portion of the second bracket lower surface.

14. A side skateboard structure for use in a vehicle, the side skateboard structure comprising:
a frame comprising:
a first frame side, and
a second frame side opposing the first frame side; and
one or more side energy absorbing assemblies disposed along at least one of the first frame side or the second frame side, each of the side energy absorbing assemblies comprising:
a first bracket comprising:
a first bracket upper surface, the first bracket upper surface comprising an s-shaped cross-section, and
a first bracket side surface extending downward from the first bracket upper surface;
a second bracket comprising:
a first end,
a second end opposing the first end,
a second bracket lower surface extending between the first end and the second end, and
a second bracket side surface extending between the first end and the second end and extending upward from the second bracket lower surface, wherein at least a portion of the second bracket side surface is coupled to at least a portion of the first bracket side surface.
